(19) United States
(12) Patent Application Publication
(10) Pub. No.: US 2006/0290647 A1
(43) Pub. Date: Dec. 28, 2006

(54) Optical waveguided dashboard display

(75) Inventors: Ram Oron, Rehovot (IL); Doron Nevo, Ra'anana (IL); Moshe Oron, Rehovot (IL)

Correspondence Address: Stephen G. Rudisill;JENKENS & GILCHRIST, A PROFESSIONAL CORPORATION, 225 W. Washington, Ste. 2600, Chicago, IL, 60606-3418, US

(73) Assignee: KiloLambda Technologies Ltd.

(21) Appl. No.: 11/474,872

(22) Filed: Jun. 26, 2006

Related U.S. Application Data
(60) Provisional application No. 60/694,609, filed on Jun. 28, 2005.

(51) Int. Cl. G09G 3/36

(52) U.S. Cl. 345/102

(57) ABSTRACT

An all-optical automotive, aircraft, marine and industrial dashboard display having embedded passive waveguides and illuminators, fed by a replaceable central unit of light sources and their controls, called the “light box,” minimizing the number of light sources required, and permitting elimination of the multiplicity of electrical cable connections from the respective sensors to the display element(s).

### CROSS-REFERENCE TO RELATED APPLICATIONS

This application is related to and claims priority to U.S. Provisional Patent Application Ser. No. 60/694,609 filed Jun. 28, 2005, titled “Optical Waveguided Dashboard Display,” which is incorporated herein in its entirety.

### FIELD OF THE INVENTION

The present invention relates to an all-optical automotive, aircraft, marine and industrial dashboard display, and particularly to a dashboard display having embedded passive waveguides and illuminators, fed by a replaceable central unit of light sources and their controls, and the system for generating these illuminators. More particularly, it relates to a display system in which a plurality of parameters relating to different operating, or other conditions in the vehicle, are to be displayed on a small surface area, the parameters being derived from sensors positioned at widely dispersed locations, and particularly to such a display system suitable for automotive, aircraft, marine and industrial dashboard displays used to display the customary information on the dashboards of vehicles, without requiring a multiplicity of connecting electrical cable connections from the respective sensors to the display element.

### BACKGROUND OF THE INVENTION

Automotive, aircraft, marine and industrial instrument displays, that in the past and present are using miniature incandescent lamps, are today replaced by light-emitting diodes (LEDs). The LEDs are becoming popular because they offer higher electrical efficiency, unfiltered colored light, lower heat generation, and a longer lifetime. The amount of LEDs in displays is large; many cars have more than 100 different light sources.

The use of diodes as light sources, embedded in the dashboard, appears already in U.S. Pat. No. 4,594,572 patent by Haubner, et al. 1986.

Organic light-emitting diodes (OLEDs) in automotive dashboard displays are making their way in three new automobiles: the Aston-Martin DB9, the Jeep Grand Cherokee and the Chevrolet Corvette.

Displays made using OLEDs offer one great advantage: low cost, over other kinds of LEDs

The use of light guides in automotive applications appear in U.S. Pat. No. 6,305,813 by Lekson, et al. and patents cited therein, describing center high mount stop-lights, using a light guide, for exterior automotive lighting

The use of a light pipe in an automotive display illumination system, where the output from a light source is coupled into one or more thick plastic light pipes, which direct the light to various graphics, was described in the open literature. The light pipes are fabricated from a clear plastic, typically polycarbonate or acrylic, by injection molding. At present, color-filtered incandescent bulbs are most commonly used in conjunction with these light pipes.

Still today, many light sources, of many kinds, are placed at different locations, feeding the dashboard display. And there is a need for a ‘light source free’ and totally passive, dashboard display, fed by a single, multi element, light source. This is described in the invention.

### SUMMARY OF THE INVENTION

In one particularly innovative aspect, the present invention is an all-optical automotive, aircraft, marine and industrial dashboard display having embedded passive waveguides and illuminators, fed by a replaceable central unit of light sources and their controls, called the “light box,” minimizing the number of light sources required, omitting the multiplicity of electrical cable connections from the respective sensors to its display element.

According to another embodiment of the present invention, an optical waveguided automotive, aircraft, marine and industrial dashboard display having embedded passive waveguides and illuminators, where the illuminators are of three geometrical types, a point light source, a line light source and an area light source, created by non imaging illuminators and/optical scatterers. The output of each light source is spread over angles up to a whole hemisphere.

According to another embodiment of the present invention, an optical waveguided automotive, aircraft, marine and industrial dashboard display having multiple embedded passive waveguides leading to one main light supply, namely a light box, supplying the light to every waveguide separately. The light output from the light box goes through the embedded waveguides, which allow the light to be steered around various mechanical obstacles within the dashboard.

According to another embodiment of the present invention, an optical waveguided automotive, aircraft, marine and industrial dashboard display having multiple embedded passive waveguides leading to one main light supply, namely a light box, where the light box is a single, multi diode, multi color, light source, each controlled separately by the control unit according to the parameter to be displayed, where the light box may contains waveguide for distributive lighting from one source into plurality of waveguides and a controlled light switch, able to switch light sources from one waveguide to another, allowing the introduction of spares and reducing the number of light sources needed.

According to another embodiment of the present invention, more than one waveguide and illuminator may lead to a single illuminated area so as to achieve mixed color of illumination, greater illumination uniformity, illumination in a required direction or specific light levels on a given area or a graphic screen on the area.

According to another embodiment of the present invention, the light box may be further used to supply more than the dashboard, leading waveguides to other interior lights, e.g., cup holders, door locks, window controls etc.

According to another embodiment of the present invention, overlay of some displays in the same display area may be achieved by building arrays of scatterers or illuminators and lighting them only when needed.

According to another embodiment of the present invention, light intensity, pulsing, and color can be changed by the control, in the same displayed area.

According to another embodiment of the present invention, it is possible to use back lighted pre-fabricated fixed symbols as well as back lighting of liquid crystals display, on the optical waveguided automotive dashboard display.

According to another embodiment of the present invention, a whole light box unit may be easily replaced upon failure.

According to another embodiment of the present invention, a whole light box unit may be replaced, containing a different set of colors to please the individual taste or need of the driver.

According to another embodiment of the present invention, a scattering end piece of a waveguide may be used as a point, line or area source

### BRIEF DESCRIPTION OF THE DRAWINGS

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a block diagram of an optical waveguided automotive, aircraft, marine and industrial dashboard display system in accordance with the embodiment of the present invention;

FIG. 2 is a schematic representation of an example of a point light source on the optical dashboard;

FIG. 3 is a schematic representation of an example of a line light source on the optical dashboard;

FIG. 4 is a schematic representation of an example of a back illuminated image as a light source on the optical dashboard;

FIG. 5 is a schematics of the waveguided automotive, aircraft, marine and industrial dashboard display;

FIG. 6 is a schematics of two examples for generating a point light source on dashboard;

FIG. 7 is a schematics of two examples for generating a line light source on dashboard;

FIG. 8 is a schematics of two examples for generating an area light source on dashboard;

FIG. 9 is schematics of the various waveguides in 3D; and

FIG. 10 is schematics of illumination of the internal circumference of a circle.

### DETAILED DESCRIPTION OF THE ILLUSTRATED EMBODIMENT

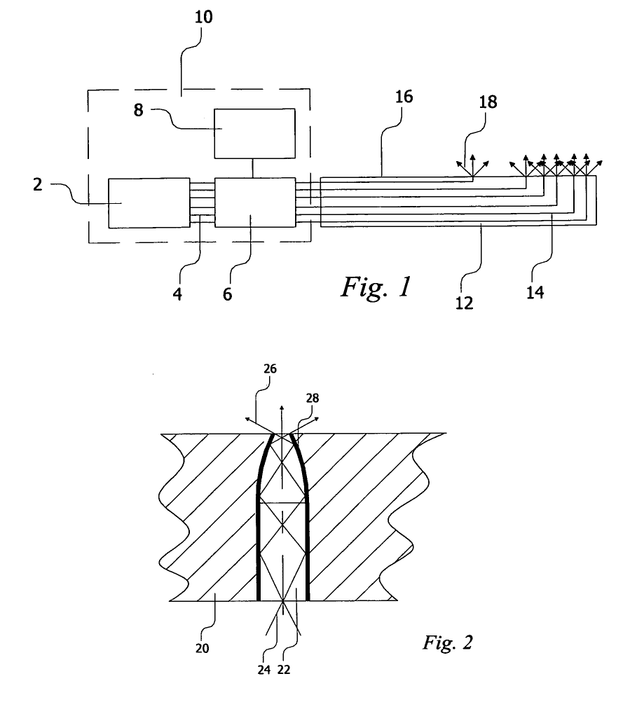

Referring now to FIG. 1, there is shown a block diagram of an optical waveguided automotive, aircraft, marine and industrial dashboard display system, where a light source 2, e.g., an array of photodiodes of one or more colors, is delivering each light beam through an optical waveguide array 4 to a temporal switch 6, able to switch on-off, dimming, pulsing and route controlling of the various inputs of optical waveguide array 4 on their way out to the all-optical automotive, aircraft, marine and industrial dashboard display 12 having embedded passive waveguides 14 and illuminators at their ends by surface 16. The operation of the switch 6 is controlled by a computer chip 8, e.g., a microprocessor. The units 4, 6, and 8 form together the light box 10. The light 18 from the surface 16, exiting from the illuminators, impinges on the driver's eyes.

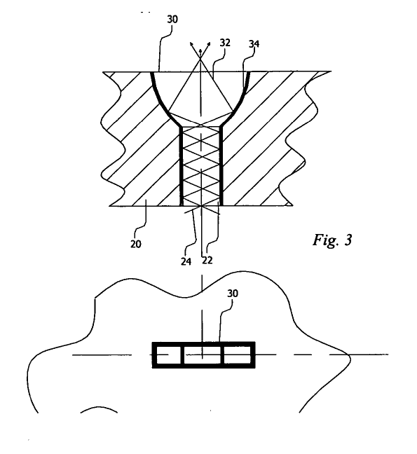

FIG. 2 illustrates one of the basic building blocks of the display, namely, a point light source at the external surface of the all-optical automotive dashboard display 20, where light rays 24 come through the waveguide and into illuminator 22, which is made of transparent polymer, shaped as an axial symmetry (round cross section, 3D) non-imaging concentrator (e.g., compound parabolic concentrator (CPC)) having an output port at the surface, where, due to the design of the non-imaging concentrator, the light beams 26 come out uniformly in a close to hemisphere angles. The non-imaging concentrator may be coated with a thin layer of reflecting material 28, e.g., aluminum or silver, in cases where the total internal reflection (TIR) is not enough to lead the light beam forward.

FIG. 3 illustrates another basic building block of the display, namely, a line light source, at the external surface of the all-optical automotive, aircraft, marine and industrial dashboard display 20, where light rays 24 come through the waveguide and into illuminator 22, which is made of transparent polymer, shaped as a plane symmetry (rectangular cross section 2D) non-imaging concentrator (e.g., compound parabolic concentrator (CPC)) having an output port 30, at the surface, where, due to the design of the non-imaging concentrator, the light beams 32 come out uniformly in close-to-hemisphere angles. The non-imaging concentrator may be coated with a thin layer of reflecting material 34, e.g., aluminum or silver, in cases that the total internal reflection (TIR) is not enough to lead the light beam forward. The lower part shows a view of the opening at the surface 30 from the top, depicting the rectangular shape, of a line pattern.

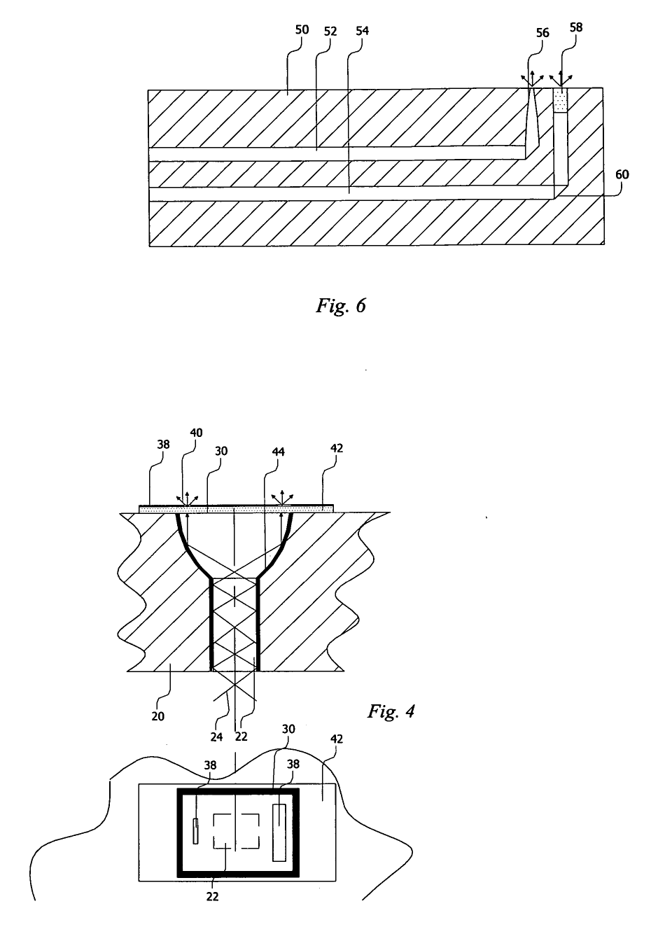

FIG. 4 illustrates another basic building block of the display, namely, an area light source, at the external surface of the all-optical automotive dashboard display 20, where light rays 24 come through the waveguide and into illuminator 22, which is made of transparent polymer, shaped as a two plane symmetry (rectangular cross section 2D) non-imaging concentrator (e.g., compound parabolic concentrator (CPC)) having an output port 30, at the surface, where, due to the design of the non-imaging concentrator, the light beams 32 come out uniformly. The non-imaging concentrator may be coated with a thin layer of reflecting material 42, e.g., aluminum or silver, in cases that the total internal reflection (TIR) is not enough to lead the light beam forward. The opening 30 may be covered by a scatter glass 42 having a printed partially opaque pattern 38 on its top, where light 40 passes through the transparent parts of the pattern 38 and is spread in large angles due to the scatter glass 42. The lower part shows a view of the opening at the surface 30 from the top, depicting the rectangular shape, of a rectangular area pattern as well as the scatter glass 42 and the openings in the pattern 38.

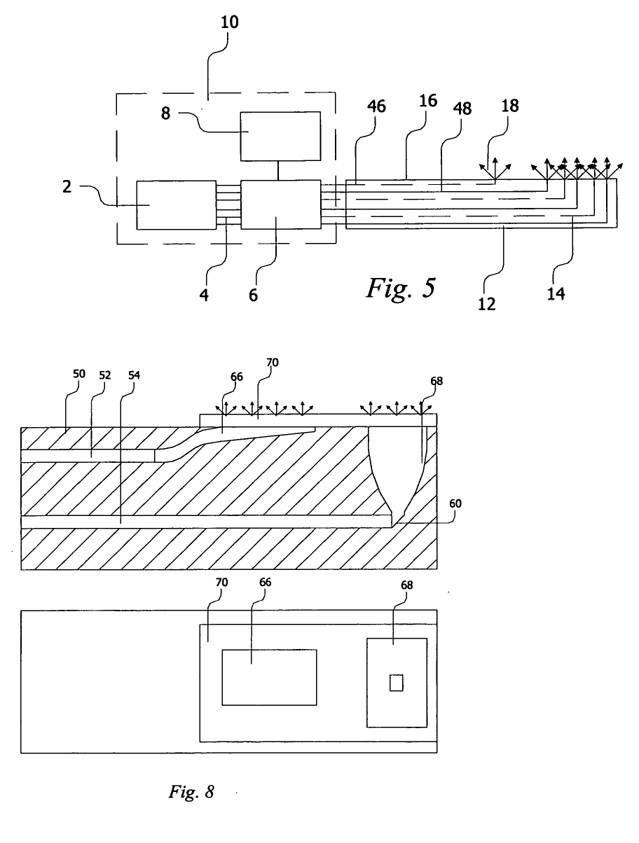

FIG. 5 illustrates an array of basic units like these described in FIGS. 2, 3 and 4, where a two-dimensional array can deliver a temporally different (each fiber in a different time) spatial pattern. At one time, the pattern generated by the dashed waveguides 46 appears, and at another time, the pattern generated by the full line waveguides 48 appears, both in the same dashboard area 16.

FIG. 6 illustrates two examples for generating a point light source on dashboard 50 where the light input is through fiber-like waveguides 52 and 54 leading light to a 45° mirror (in many cases TIR mirror) 60 toward the surface through a non-imaging concentrator 56 or through a scatterer end piece 58. Both units emit light to about a hemisphere.

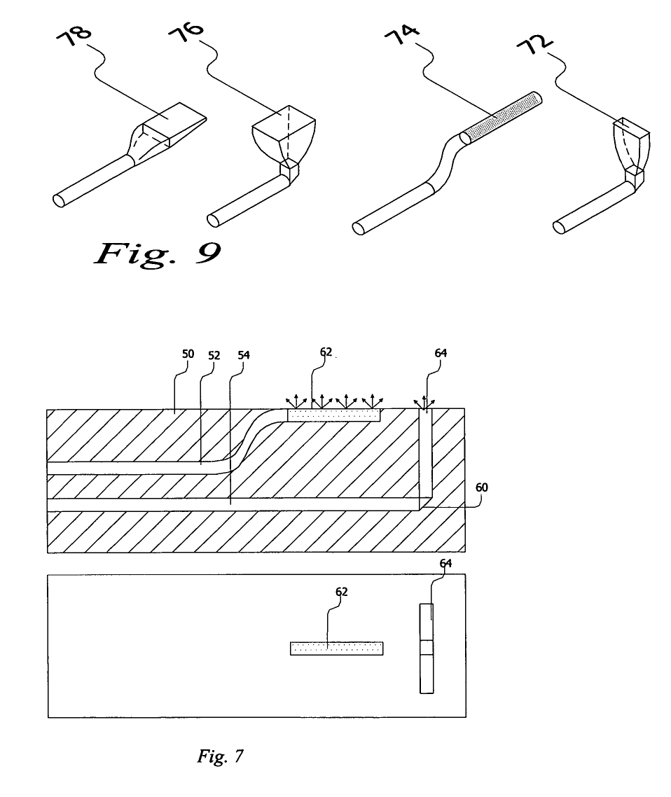

FIG. 7 illustrates two examples for generating a line light source on dashboard 50, the first where the light input is through a fiber-like waveguide 52 leading the light to a scattering fiber 62 at the surface, and the second where the light input is through a fiber-like waveguide 54 leading light to a 45° mirror (in many cases TIR mirror) 60 toward the surface through a non-imaging optical illuminator 64, spreading the light in one dimension (a through like non-imaging reflective illuminator). Both units emit light to about a hemisphere. The lower part of the drawing is a top view.

FIG. 8 illustrates two examples for generating an area light source on dashboard 50, the first where the light input is through a fiber like waveguide 52 leading the light to a wedged waveguide, illuminating its upper surface uniformly, and then through scatter plate 70, which is similar to scatter plate scatter glass 42 in FIG. 4, having a printed partially opaque pattern on its top, where light is passing through the transparent parts of the pattern and spread in large angles due to the scatter glass 70. In the second example, a fiber-like waveguide 54 leads light to a 45° mirror (in many cases TIR mirror) 60 toward the surface through a non-imaging optical illuminator 68, spreading the light in two dimensions illuminating its upper surface uniformly, and then through scatter plate 70, which is similar to scatter plate scatter glass 42 in FIG. 4, having a printed partially opaque pattern on its top, where light is passing through the transparent parts of the pattern and spread in large angles due to the scatter glass 70. Both units emit light to about a hemisphere. The lower part shows a top view of the openings at the surface.

FIG. 9 shows the various light sources with their transparent waveguides in three dimensions for clarity. 72 is the line scattering source, 74 is the line non-imaging source, 76 is the area non-imaging source and 78 is the wedged waveguide, emitting light that is TIR reflected inside the wedge, illuminating the area uniformly. All are made of transparent material, e.g., organic polymers.

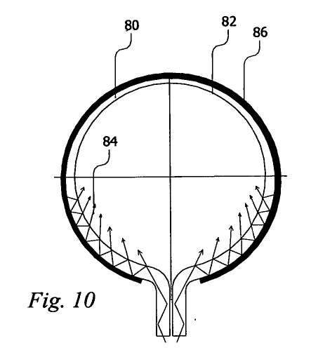

FIG. 10 is a schematic illustration of illumination of the internal circumference of a circle. Light 84 enters waveguide 80, and is guided along the circumference of a circle 82. The waveguide 80 has a diminishing radial width, large at bottom and thin on top, optimized to inject uniform light into circle 82. This shape can be implemented as a single wedge-like shape around the whole circumference, or as more than one, e.g., two (as drawn), wedge-like shapes around the circumference 82, enabling the use of more than a single light source in parallel. Minimizing losses can be achieved by applying reflective coating 86 on the outer surface.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

What is claimed is:

1. An all-optical automotive, aircraft, marine and industrial dashboard display having embedded passive waveguides and illuminators, fed by a light box that includes at least one light source, an optical waveguide array, and a control unit for controlling the coupling of said light source and said optical waveguide array.

2. The dashboard display of claim 1 in which said illuminators include at least one geometrical type selected from the group consisting of a point light source, a line light source and an area light source, created by non-imaging illuminators and optical scatterers.

3. The dashboard display of claim 1 which includes multiple embedded passive waveguides emerging from said light box, supplying light to each of said embedded passive waveguides separately.

4. The dashboard display of claim 1 in which said light box is a single, multi diode, multi-color, light source, each controlled separately by said control unit according to the parameter to be displayed, and said light box contains waveguides for distributive lighting from one source into a plurality of waveguides in said array and a controlled light switch for switching light sources from one waveguide to another, allowing the introduction of spares and reducing the number of light sources needed.

5. The dashboard display of claim 1 wherein more than one of said embedded passive waveguides and said illuminators lead to a single illuminated area so as to achieve mixed colors of illumination, greater illumination uniformity, illumination in a required direction or specific light levels on a given area or a graphic screen on the area.

6. The dashboard display of claim 1 wherein said light box supplies more than said dashboard, leading waveguides to other interior and exterior lights.

7. The dashboard display of claim 1 which includes an overlay of some displays in the same display area, comprising arrays of scatterers or illuminators that can be illuminated when needed.

8. The dashboard display of claim 1 wherein said control unit is capable of changing light intensity, pulsing, and color.

9. The dashboard display of claim 1 which includes back-lighted pre-fabricated fixed symbols and back lighting of liquid crystal displays.

10. The dashboard display of claim 1 wherein said light box is replaceable upon failure.

11. The dashboard display of claim 1 wherein said light box unit is replaceable to provide a different set of colors to please the individual taste of the user.

12. The dashboard display of claim 1 which includes a scattering end piece of a waveguide used as a point, line or area source.

13. The dashboard display of claim 1 in which a circular area is illuminated through its circumference by a wedge-shaped circumference waveguide.

14. The dashboard display of claim 1 wherein said control unit includes a temporal switch controlled by a microprocessor.
